(19) United States
(12) Patent Application Publication
(10) Pub. No.: US 2008/0284284 A1
(43) Pub. Date: Nov. 20, 2008

(54) RESONANT ACTUATOR

(75) Inventors: Shinichiro KAWADA, Hikone-shi (JP); Katsuhiro HORIKAWA, Toyama-shi (JP); Masahiko KIMURA, Kusatsu-shi (JP); Hirozumi OGAWA, Yasu-shi (JP)

Correspondence Address: MURATA MANUFACTURING COMPANY, LTD.;C/O KEATING & BENNETT, LLP, 1800 Alexander Bell Drive, SUITE 200, Reston, VA, 20191, US

(73) Assignee: MURATA MANUFACTURING CO., LTD., Nagaokakyo-shi (JP)

(21) Appl. No.: 12/172,463

(22) Filed: Jul. 14, 2008

Related U.S. Application Data
(63) Continuation of application No. PCT/JP2006/325405, filed on Dec. 20, 2006.

(30) Foreign Application Priority Data
Jan. 17, 2006 (JP) 2006-008820
May 11, 2006 (JP) 2006-132338

(51) Int. Cl. H02N 2/04

(52) U.S. Cl. 310/323.01

(57) ABSTRACT

A resonant actuator includes a driving unit having a displacement element that vibrates at a resonance frequency or in a frequency range in the vicinity of a resonance frequency and having a driven member that is driven by the displacement element, in which the displacement element has a piezoelectric ceramic body made of a bismuth layered compound. The displacement direction of the displacement element is preferably substantially the same as the direction of polarization of the piezoelectric ceramic body. The bismuth layered compound is preferably oriented such that the direction of the c crystallographic axis is substantially perpendicular to the direction of polarization of the piezoelectric ceramic body. More preferably, the degree of c-axis orientation is determined to be at least about 75% by the Lotgering method. Thereby, it is possible to provide a resonant actuator having a large saturated vibration velocity, minimizing reductions in the resonance frequency fr and the mechanical quality factor Qm without the destabilization of the vibration velocity even at a high vibration velocity, and having a large amount of displacement even at a high electric field.

### BACKGROUND OF THE INVENTION

1. Field of the Invention

The present invention relates to resonant actuators and, more specifically, to a resonant actuator including a piezoelectric ceramic material.

2. Description of the Related Art

The amount of displacement of a piezoelectric actuator depends upon a piezoelectric constant d. Thus, research and development of piezoelectric ceramic materials based on Pb(Zr, Ti)O₃ (lead zirconate titanate: hereinafter, referred to as “PZT”) with a large piezoelectric constant have been actively conducted.

For example, Sadayuki Takahashi, “Atsuden Zairyou No Shintenkai (Novel Development of Piezoelectric Material)”, TIC Corp., Nyuu Seramikkusu (New Ceramics), VOL. 11, No. 8 (1988), p. 29-34, describes large amplitude properties of a piezoelectric ceramic material because power devices such as piezoelectric actuators utilize large amplitude elastic vibrations of piezoelectric ceramic materials.

The above-identified publication reports the following: A vibration velocity (=vibration amplitude×frequency) changes in proportion to, in theory, an applied electric field E. Where a PZT piezoelectric ceramic material operates at a resonance frequency, when the electric field exceeds a specific level, the vibration velocity decreases gradually from the theoretical value and ultimately is saturated. This publication also describes the relationship between the limit of the vibration velocity of PZT and the driving electric field and reports that although the limit of the vibration velocity varies depending upon material compositions, the maximum vibration velocity of PZT piezoelectric ceramic materials does not exceed about 1 m/s.

Sadayuki Takahashi, “Hai Pawa Zairyou No Hyouka (Evaluation of High-Power Material)”, TIC Corp., Nyuu Seramikkusu (New Ceramics) (1995), No. 6, p. 17-21, reports an evaluation method of piezoelectricity and the relationship between the composition of a PZT piezoelectric ceramic material and high-power characteristics such as vibration level characteristics because in fields of piezoelectric actuators, high-power materials having high vibration levels are required.

This second publication also reports that where a PZT piezoelectric ceramic material operates at the resonance frequency, the resonance frequency fr and mechanical quality factor Qm are reduced when the vibration level exceeds a specific value.

Δs described in Sadayuki Takahashi, “Atsuden Zairyou No Shintenkai (Novel Development of Piezoelectric Material)”, TIC Corp., Nyuu Seramikkusu (New Ceramics), VOL. 11, No. 8 (1988), p. 29-34, where PZT piezoelectric ceramic materials in the related art are used for resonant actuators, the vibration velocity is reduced below the theoretical value and destabilized at an applied electric field of a specific value or more. Ultimately, the vibration velocity is saturated.

That is, in resonant actuators using PZT piezoelectric ceramic materials, the vibration velocity exceeding 1 m/s is not achieved because of the saturation of the vibration velocity at a higher vibration velocity. Thus, a resonant actuator having a large amount of displacement cannot be obtained. Moreover, at a high electric field of a specific value or greater, the vibration velocity is not proportional to the applied electric field E and is less than the theoretical value. Thus, a feedback circuit that controls the vibration velocity to the theoretical value is required, thereby leading to a complicated device.

Furthermore, as described in Sadayuki Takahashi, “Hai pawa zairyou no hyouka (Evaluation of high-power material)”, TIC Corp., Nyuu seramikkusu (New Ceramics) (1995), No. 6, p. 17-21, where PZT piezoelectric ceramic materials are used for resonant actuators, it is known that the resonance frequency fr and mechanical quality factor Qm are reduced as the vibration velocity increases. Thus, a feedback circuit which follows a change in resonance frequency fr is required, leading to a complicated device. Furthermore, a reduction in the mechanical quality factor Qm results in an increase in mechanical loss, which leads to an increase in the amount of heat generated in a piezoelectric ceramic material. Therefore, it is difficult to use the resonant actuator at a high vibration velocity.

### SUMMARY OF THE INVENTION

To overcome the problems described above, preferred embodiments of the present invention provide a resonant actuator having a large saturated vibration velocity, minimizing reductions in resonance frequency fr and mechanical quality factor Qm without the destabilization of the vibration velocity even at a high vibration velocity, and having a large amount of displacement even at a high electric field.

For power devices such as resonant actuators requiring a large amount of displacement, a high piezoelectric constant d has been considered to be important. Thus, only piezoelectric ceramic materials based on PZT with a high piezoelectric constant d has been studied.

However, as described in “Description of the Related Art”, in PZT piezoelectric ceramic materials, the increase in vibration velocity v results in the reduction in mechanical quality factor Qm and in resonance frequency fr. Furthermore, the vibration velocity v is not proportional to the applied electric field E at a high electric field of a specific value or more and is saturated at a value below the theoretical value. Therefore, a resonant actuator having a high vibration velocity is not obtained.

The inventors have conducted intensive studies of various materials and have discovered the following: The use of a piezoelectric ceramic body as a displacement element, the piezoelectric ceramic body being made of a bismuth layered compound, results in a high saturated vibration velocity, thereby minimizing the reduction in mechanical quality factor Qm and in resonance frequency fr without the destabilization of vibration velocity v even at a high vibration velocity v. Furthermore, the inventors have found that the vibration velocity v changes in approximate proportion to the applied electric field E without saturating the vibration velocity v even at a high electric field of a specific value or more.

A resonant actuator according to a preferred embodiment of the present invention includes at least one driving unit having a displacement element that vibrates at a resonance frequency or in a frequency range in the vicinity of a resonance frequency, and includes a driven member that is driven by the displacement element, in which the displacement element includes a piezoelectric ceramic body made of a bismuth layered compound.

The bismuth layered compound has a large anisotropy. Where a displacement direction is substantially the same as a polarization direction, the vibration velocity v is much greater than that of where the displacement direction is substantially perpendicular to the polarization direction, thereby providing a resonant actuator having a large amount of displacement.

That is, in the resonant actuator according to this preferred embodiment of the present invention, the displacement direction of the displacement element is substantially the same as the direction of polarization of the piezoelectric ceramic body.

The inventors have further conducted intensive studies and have found that the bismuth layered compound oriented in such a manner that the direction of the c crystallographic axis is substantially perpendicular to the direction of polarization of the piezoelectric ceramic body results in an increase in mechanical quality factor Qm when the vibration velocity v is increased.

Moreover, in the resonant actuator, the vibration velocity v is proportional to the product of the piezoelectric constant d and the mechanical quality factor Qm. Thus, since the mechanical quality factor Qm is not reduced even when the piezoelectric constant d is low, the vibration velocity v can be increased. Therefore, the bismuth layered compound has a greater amount of displacement than those of PZT piezoelectric ceramic materials.

That is, in the resonant actuator according to this preferred embodiment of the present invention, the bismuth layered compound is oriented such that the direction of the c crystallographic axis is substantially perpendicular to the direction of polarization of the piezoelectric ceramic body.

In particular, where the degree of c-axis orientation F is determined to be about 75% or more by the Lotgering method, a change in resonance frequency fr can be suppressed even when the vibration velocity v is increased. Furthermore, in this case, savings in power consumption W are achieved. Moreover, a high vibration velocity v can be obtained at a relatively low applied electric field E, which is preferable.

That is, in the resonant actuator according to this preferred embodiment of the present invention, the degree of c-axis orientation is determined to be about 75% or more by the Lotgering method.

According to the preferred embodiment of the present invention described above, the resonant actuator includes a driving unit having a displacement element that vibrates at a resonance frequency or in a frequency range in the vicinity of a resonance frequency, and includes a driven member that is driven by the displacement element, in which the displacement element has a piezoelectric ceramic body composed of a bismuth layered compound. This results in an increased saturated vibration velocity, minimized reductions in resonance frequency fr and mechanical quality factor Qm without destabilizing the vibration velocity even at a high vibration velocity, and a change in vibration velocity v that is approximately proportional to the applied electric field E within a wide electric field range, as compared to when a PZT compound is used as a piezoelectric ceramic body. Therefore, it is possible to obtain the resonant actuator having a high vibration velocity v without saturation of the vibration velocity v at high applied electric fields and having a large amount of displacement. Furthermore, a reduction in resonance frequency fr is minimized even when the vibration velocity v is increased, and the vibration velocity v changes approximately proportionally to the applied electric field E. This eliminates a feedback circuit configured to control the resonance frequency fr and the vibration velocity v, thereby leading to the simplification, cost reduction, and miniaturization of the device.

The displacement direction of the displacement element is the same as the polarization direction of the piezoelectric ceramic body. Thus, at the same applied electric field, the vibration velocity v is higher than that in the case of the displacement direction perpendicular to the polarization direction, thereby further improving the properties of the resonant actuator.

The bismuth layered compound is oriented in such a manner that the direction of the c crystallographic axis is orthogonal to the polarization direction of the piezoelectric ceramic body, thereby increasing the mechanical quality factor Qm. This results in an increase in vibration velocity v that can be stably used, thereby providing the resonant actuator having a larger amount of displacement.

In particular, in the case where the degree of c-axis orientation F is determined to be 75% or more by the Lotgering method, a change in resonance frequency fr can be suppressed even when the vibration velocity is increased. Furthermore, in this case, savings in power consumption W can be achieved. Moreover, a high vibration velocity v can be obtained at a relatively low applied electric field E.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic diagram illustrating a resonant actuator according to a preferred embodiment of the present invention.

FIG. 2 is a cross-sectional view of a displacement element according to a preferred embodiment of the present invention.

FIGS. 3A and 3B are schematic diagrams illustrating the principle of operation of a resonant actuator.

FIG. 4 is a schematic perspective view of a specimen of each of samples 1 to 3 in “EXAMPLE 1”.

FIG. 5 is a schematic perspective view of a specimen of sample 4 in “EXAMPLE 1”.

FIG. 6 is a schematic block diagram of a measuring device used in “EXAMPLE 1”.

FIG. 7 shows the dependence of the power consumption on vibration velocity.

FIG. 8 shows the dependence of the mechanical quality factor on vibration velocity.

FIG. 9 shows the dependence of the resonance frequency on vibration velocity.

FIG. 10 shows the dependence of the rate of displacement on electric field.

FIG. 11 shows the dependence of the resonance frequency on vibration velocity in “EXAMPLE 2”.

FIG. 12 shows the dependence of the power consumption on vibration velocity in “EXAMPLE 2”.

FIG. 13 shows the dependence of the vibration velocity on electric field.

### DETAILED DESCRIPTION OF PREFERRED EMBODIMENTS

Preferred embodiments of the present invention will be described in detail below.

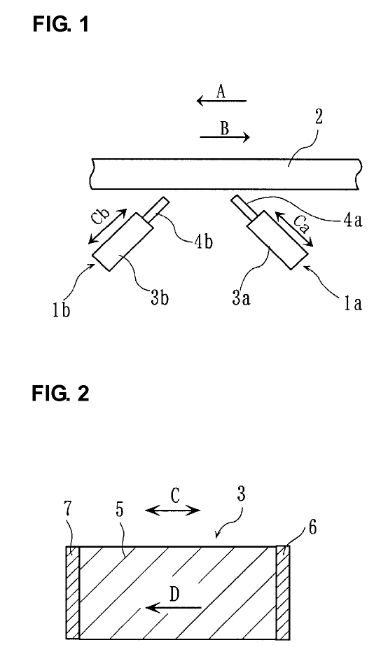

FIG. 1 is a cross-sectional view of a resonant actuator according to a preferred embodiment of the present invention. In this preferred embodiment, the resonant actuator preferably includes two driving units.

The resonant actuator includes driving units 1 (first and second driving units 1a and 1b) and a driven member 2 that is driven by the driving units 1 in the direction of arrow A or arrow B.

Each of the driving units 1 (first and second driving units 1a and 1b) includes a displacement element 3 (first displacement element 3a or second displacement element 3b) arranged to vibrate at a resonance frequency to be displaced in the directions arrow Ca or arrow Cb, and a vibrating reed 4 (first vibrating reed 4a or second vibrating reed 4b) arranged to protrude from a corresponding one of the displacement elements 3.

Δs shown in FIG. 2, each of the displacement elements 3 includes a single-plate piezoelectric ceramic body 5 that is polarized in the direction of arrow D and preferably made of a bismuth layered compound, for example, and electrodes 6 and 7 arranged on both main surfaces and made of, for example, Ag. Application of an electric field to the electrodes 6 and 7 causes vibration of a corresponding one of the displacement elements 3 at a resonance frequency fr in the directions of arrow C.

The reason the piezoelectric ceramic body 5 is preferably made of a bismuth layered compound, for example, as described above is as follows.

Unlike PZT piezoelectric ceramic materials, the use of the bismuth layered compound for a resonant actuator minimizes reductions in the resonance frequency fr and the mechanical quality factor Qm without the destabilization of the vibration velocity v even at a higher vibration velocity v. Moreover, even when a high electric field having a desired value or greater is applied, the vibration velocity v is increased in approximate proportion to the applied electric field E without destabilization, thereby enabling a resonant actuator having a large displacement.

The reason the bismuth layered compound provides the above-described effect, unlike PZT compounds, is believed to be as follows.

PZT compounds have a perovskite crystal structure (general formula: ABO₃) and a crystalline anisotropy less than those of bismuth layered compounds. Thus, an increase in vibration velocity v causes the rotation of non-180° domains relatively easily. This results in a reduction in the resonance frequency fr and the mechanical quality factor Qm as the vibration velocity v increases.

In contrast, bismuth layered compounds have periodically arranged bismuth layers that are substantially perpendicular to the c crystallographic axis. Thus, substantially no rotation of non-180° domains occurs. This inhibits the reduction in the resonance frequency fr and the mechanical quality factor Qm even at a higher vibration velocity v.

Examples of such bismuth layered compounds that can be used include, but are not limited to, Bi₂SrNb₂O₉, BiWO₆, CaBiNb₂O₉, BaBiNb₂O₉, PbBi₂Nb₂O₉, Bi₃TiNbO₉, Bi₃TiTaO₉, Bi₄Ti₃O₁₂, SrBi₃Ti₂NbO₁₂, BaBi₃Ti₂NbO₁₂, PbBi₃Ti₂NbO₁₂, CaBi₄Ti₄O₁₅, SrBi₄Ti₄O₁₅, BaBi₄Ti₄O₁₅, PbBi₄Ti₄O₁₅, Na_{0.5}Bi_{4.5}Ti₄O₁₅, K_{0.5}Bi₄Ti₄O₁₅, Ca₂Bi₄Ti₅O₁₈, Sr₂Bi₄Ti₅O₁₈, Ba₂Bi₄Ti₅O₁₈, Bi₆Ti₃WO₁₈, Bi₇Ti₄NbO₂₁, and Bi₁₀Ti₃W₃O₃₀.

Like this preferred embodiment, the displacement direction C is preferably the same as the polarization direction D. Δs described above, the piezoelectric ceramic body 5 made of such a bismuth layered compound minimizes reductions in the resonance frequency fr and the mechanical quality factor Qm without the destabilization of the vibration velocity v even at a higher vibration velocity v. Bismuth layered compounds have a large anisotropy. With the application of the same electric field, therefore, a high vibration velocity v can be achieved when the displacement direction is the same as the polarization direction as compared to that in which the displacement direction is substantially perpendicular to the polarization direction. Thus, it is possible to obtain a resonant actuator having a greater amount of displacement.

Furthermore, the bismuth layered compound is preferably oriented such that the direction of the c crystallographic axis is substantially perpendicular to the polarization direction D of the piezoelectric ceramic body 5.

That is, since the bismuth layered compound has a large anisotropy as described above, the fact that the bismuth layered compound is preferably oriented such that the direction of the c crystallographic axis is substantially perpendicular to the polarization direction D of the piezoelectric ceramic body 5 results in an increase in mechanical quality factor Qm.

The relationship between the vibration velocity v and the applied electric field E is represented by formula (1).

V∝C_{E}^{1/2}·d·Qm·E (1)

where C represents an elastic stiffness coefficient.

Formula (1) clearly shows that the vibration velocity v is proportional to the product of the piezoelectric constant d and the mechanical quality factor Qm. The bismuth layered compound has a piezoelectric constant d less than those of PZT piezoelectric ceramic materials as described above but has a large mechanical quality factor Qm, thus resulting in a high vibration velocity v. Therefore, it is possible to obtain a resonant actuator having a large amount of displacement.

Δs described above, the vibration velocity v is increased in approximate proportion to the applied electric field E even at a high applied electric field E. This results in stable operation even at a high electric field.

The fact that the bismuth layered compound is preferably oriented such that the direction of the c crystallographic axis is substantially perpendicular to the polarization direction D of the piezoelectric ceramic body 5 results in an increase in mechanical quality factor Qm. The degree of c-axis orientation F is preferably determined to be at least about 75% by the Lotgering method.

That is, the degree of c-axis orientation F is calculated by the Lotgering method with formula (2).

$$F = \frac{\frac{\sum I ( 001 )}{\sum I ( hkl )} - \frac{\sum Io ( 001 )}{\sum Io ( hkl )}}{1 - \frac{\sum Io ( 001 )}{\sum Io ( hkl )}} \times 100 \qquad ( 2 )$$

where ΣI(001) represents the sum of intensities of XRD peaks from the (001) plane representing the c-axis orientation of a measured sample; ΣI(hkl) represents the sum of intensities of XRD peaks from all crystal planes (hkl) of the measured sample; ΣIo(001) represents the sum of intensities of XRD peaks from the (001) plane of a comparative sample (e.g., non-oriented sample); and ΣIo(hkl) represents the sum of intensities of XRD peaks from all crystal planes (hkl) of the comparative sample.

Where the degree of orientation F calculated by formula (2) is at least about 75%, even when the vibration velocity v is increased to about 1 m/s or more, a change in resonance frequency fr is negligible. Moreover, an increase in power consumption W is suppressed. Thus, the degree of orientation F also contributes to reduced power consumption W. In this case, furthermore, a high vibration velocity v is obtained at a relatively low applied electric field E, thus easily producing a resonant actuator having a large amount of displacement.

More preferably, therefore, the bismuth layered compound is oriented such that the direction of the c crystallographic axis is substantially perpendicular to the polarization direction D of the piezoelectric ceramic body 5, and the degree of c-axis orientation F is preferably determined to be at least about 75% by the Lotgering method.

The oriented bismuth layered compound can be easily prepared by, for example, a templated grain growth (TGG) method as described in “EXAMPLES” below. That is, for example, the oriented bismuth layered compound can be easily prepared by producing a ceramic formed article including a c-axis-oriented ceramic particles in the form of a plate and a non-oriented calcined powder and subjecting the resulting ceramic formed article to heat treatment. The degree of orientation F can be controlled by adjusting the ratio of the plate ceramic particle content and the non-oriented calcined powder content.

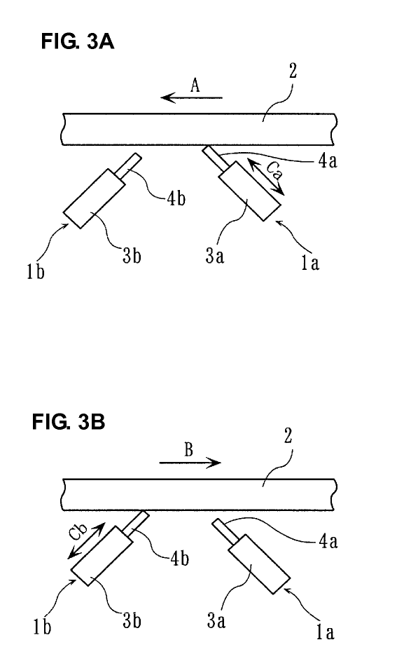

Δs shown in FIG. 3A, in the resonant actuator including the displacement elements 3, the application of an electric field to the first displacement element 3a while the first vibrating reed 4a of the driving unit 1a is pressed into contact with the driven member 2 results in the motion of the driven member 2 in the direction of arrow A owing to the vibration in the directions of arrow Ca.

Δs shown in FIG. 3B, the application of an electric field to the second displacement element 3b while the second vibrating reed 4b of the driving unit 1b is pressed into contact with the driven member 2 results in the motion of the driven member 2 in the direction of arrow B owing to the vibration in the directions of arrow Cb.

In this preferred embodiment, each of the displacement elements 3 (first and second displacement elements 3a and 3b) includes the piezoelectric ceramic body 5 made of a bismuth layered compound, thereby inhibiting the reductions in the resonance frequency fr and the mechanical quality factor Qm even at a higher vibration velocity v. Moreover, the vibration velocity v changes in approximate proportion to the applied electric field E in a wide electric-field-strength range. This eliminates a feedback circuit configured to control the resonance frequency fr and the vibration velocity v, thereby enabling the simplification, cost reduction, and miniaturization of the device.

It is difficult to use known PZT piezoelectric ceramic materials at a vibration velocity v exceeding about 1 m/s. However, the bismuth layered compound can be reliably used even at a vibration velocity v exceeding about 1 m/s, thereby improving the properties of the resonant actuator.

The present invention is not limited to the foregoing preferred embodiments. In the foregoing preferred embodiments, the resonant actuator operates at a resonance frequency. Alternatively, where the resonant actuator operates in a frequency range in the vicinity of a resonance frequency, the frequency range lying between frequencies deviating from the resonance frequency by several percentage points, the same effects and advantages can be provided.

In the foregoing preferred embodiments, the resonant actuator including the two driving units has been described. Alternatively, when the resonant actuator including one or three or more driving units, it will be obvious that the present invention may be similarly applied.

In the foregoing preferred embodiments, each of the displacement elements 3 is a single plate. Alternatively, with a displacement element having a structure including bonded ceramic green sheets or a multilayer resonant actuator obtained by co-sintering with internal electrodes, the same effects and advantages can be provided.

Examples of preferred embodiments of the present invention will be described in detail below.

### Example 1

Displacement elements of samples 1 and 2 each having a displacement direction substantially the same as a polarization direction were prepared with a non-oriented Bi₂srNb₂O₉ (hereinafter, referred to as an “SBN”) material, which is a bismuth layered compound, and a c-axis-oriented SBN material were used.

AS COMPARATIVE EXAMPLE, sample 3 having a displacement direction substantially the same as a polarization direction and sample 4 having a displacement direction substantially perpendicular to a polarization direction were prepared with a PZT material.

Methods for producing Samples will be described in detail below.

### Sample 1

SrCO₃, Bi₂O₃, Nb₂O₅, Nd₂O₃, and MnCO₃ were prepared as ceramic materials and measured such That the final composition satisfies the formula {100(Sr_{0.9}Nd_{0.1}Bi₂Nb₂O₉)+MnO}. The measured materials were charged into a ball mill with partially stabilized zirconia (PSZ) balls and water and wet-mixed for about 16 hours in the ball mill to produce a mixture.

The resulting mixture was dried and calcined at about 800° C. for about 2 hours to yield a calcined powder.

Appropriate amounts of an organic binder, a dispersant, a defoaming agent, and a surfactant were added to the resulting calcined powder. The resulting mixture was charged into a ball mill with PSZ balls and water and wet-mixed for about 16 hours in the ball mill to prepare a ceramic slurry. The ceramic slurry was formed, by a doctor blade method, into ceramic green sheets each having a thickness of about 60 μm.

A predetermined number of the ceramic green sheets were stacked. The resulting stack was press-bonded for about 30 seconds under the conditions in which the temperature was set at about 60° C. and the pressure was set at about 30 MPa to form a laminated article.

The laminated article was subjected to debinding at about 350° C. for about 5 hours and then about 500° C. for about 2 hours. Subsequently, the laminated article was fired at about 1,150° C. for about 2 hours to form a sintered block. The resulting block was cut into sintered ceramic bodies each having a length of about 7 mm, a width of about 7 mm, and a thickness of about 5 mm.

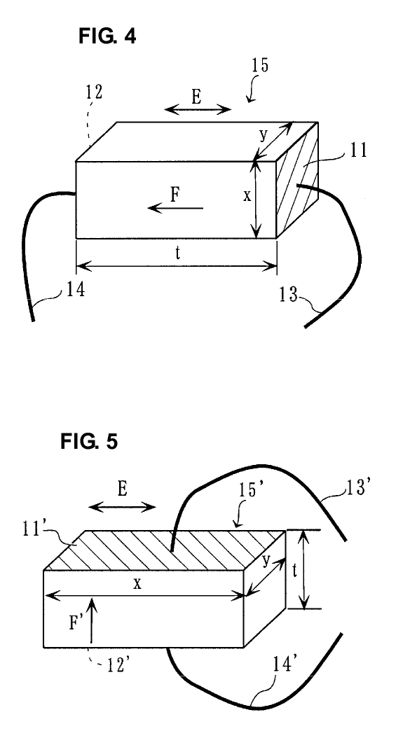

Each of the resulting sintered ceramic bodies was subjected to sputtering with a Ag target to form electrodes on both main surfaces thereof. The sintered ceramic bodies were polarized in the thickness direction by application of an electric field of about 10.0 kV/mm in an oil bath at about 200° C. for about 30 minutes. Δs shown in FIG. 4, the polarized ceramic bodies were cut with a dicer into pieces each having a width (x) of about 2 mm, a length (y) of about 2 mm, and a thickness (t) of about 5 mm. Silver leads 13 and 14 were bonded to electrode faces 11 and 12 by soldering. Thereby, SBN specimens 15 of non-oriented sample 1 having the displacement direction E substantially the same as the polarization direction F were produced.

### Sample 2

In the same manner as in sample 1, ceramic materials were measured such that the final composition satisfies the formula {100(Sr_{0.9}Nd_{0.1}Bi₂Nb₂O₉)+MnO}. The measured materials were wet-mixed for about 16 hours in a ball mill to provide a mixture. The resulting mixture was dried and calcined at about 800° C. for about 2 hours to yield a calcined powder.

A portion of the calcined powder was separated and was mixed with KCl in a ratio by weight of about 1:1. The mixture was subjected to heat treatment at about 900° C. for about 10 hours. Removal of KCl by washing with water resulted in ceramic particles.

Observation of the ceramic particles with a scanning electron microscope demonstrated that the particles are each in the form of an anisotropic plate and that the ratio (aspect ratio) of the maximum diameter φ to the height H of the plate was about 5.

The plate-shaped ceramic particles were mixed with the calcined powder in a ratio by weight of about 1:1. Appropriate amounts of an organic binder, a dispersant, a defoaming agent, and a surfactant were added to the mixture. The resulting mixture was charged into a ball mill with PSZ balls and water and wet-mixed for about 16 hours in the ball mill to prepare a ceramic slurry. The ceramic slurry was formed, by a doctor blade method, into ceramic green sheets each having a thickness of about 60 μm.

A predetermined number of the ceramic green sheets were stacked. The resulting stack was press-bonded for about 30 seconds under the conditions in which the temperature was set at about 60° C. and the pressure was set at about 30 MPa to form a laminated article.

The laminated article was subjected to debinding at about 350° C. for about 5 hours and then about 500° C. for about 2 hours. Subsequently, the laminated article was fired at about 1,150° C. for about 2 hours to form a sintered block. The plate-shaped ceramic particles were homoepitaxially grown during firing while the calcined powder was incorporated into the plate-shaped ceramic particles each serving as a seed crystal (template), thereby producing an oriented sintered block (TGG method). The sintered block was cut into oriented sintered ceramic bodies each having a length of about 7 mm, a width of about 7 mm, and a thickness of about 5 mm such that the c crystallographic axis lies in the in-plane direction of a main surface having a length of about 7 mm and a width of about 7 mm, i.e., such that the a-b plane surfaces in the thickness direction.

At this time, the degree of c-axis orientation F of the resulting oriented sintered ceramic bodies was measured by the Lotgering method.

For the oriented sintered ceramic body, intensities of XRD peaks were measured in a diffraction angle 2θ range of about 20° to about 80° with an X-ray diffractometer (radiation source: CuKα radiation). Similarly, for the non-oriented sintered ceramic body of sample 1 as a comparative sample, the intensities of XRD peaks for each oriented sintered ceramic body were measured in a diffraction angle 2θ range of about 20° to about 80°.

The sum of the intensities of the XRD peaks from the (001) plane and all crystal planes (hkl) of the oriented sintered body and the non-oriented sintered ceramic body was calculated. The degree of c-axis orientation F was determined on the basis of formula (2) described above. The results demonstrated that the degree of orientation F was about 90%.

Each of the oriented sintered ceramic bodies was subjected to sputtering with an Ag target to form electrodes on both main surfaces thereof. The oriented sintered ceramic bodies were polarized in the thickness direction by application of an electric field of about 10.0 kV/mm in an oil bath at about 200° C. for about 30 minutes. In the same manner as in sample 1, the polarized ceramic bodies were cut with a dicer into pieces each having a width (x) of about 2 mm, a length (y) of about 2 mm, and a thickness (t) of about 5 mm. Silver leads were bonded to electrode faces by soldering. Thereby, SBN specimens of sample 2 were produced, each of the SBN specimen having the displacement direction substantially the same as the polarization direction and being oriented such that the c-axis was substantially perpendicular to the polarization direction.

### Sample 3

Pb₃O₄, TiO₂, MnCO₃, and Nb₂O₅ were prepared as ceramic raw materials and measured such that the final composition satisfies the formula [Pb{(Mn_{1/3}Nb_{2/3})_{0.10}Ti_{0.46}Zr_{0.44}}O₃]. The measured materials were charged into a ball mill with PSZ balls and water and wet-mixed for about 16 hours in the ball mill to produce a mixture.

The resulting mixture was dried and calcined at about 900° C. for about 2 hours to yield a calcined powder.

Appropriate amounts of an organic binder, a dispersant, a defoaming agent, and a surfactant were added to the resulting calcined powder. The resulting mixture was charged into a ball mill with PSZ balls and water and wet-mixed for about 16 hours in the ball mill to prepare a ceramic slurry. The ceramic slurry was formed, by a doctor blade method, into ceramic green sheets each having a thickness of about 60 μm.

A predetermined number of the ceramic green sheets were stacked. The resulting stack was press-bonded for about 30 seconds under the conditions in which the temperature was set at about 60° C. and the pressure was set at about 30 MPa to form a laminated article.

The laminated article was subjected to debinding at about 350° C. for about 5 hours and then about 500° C. for about 2 hours. Subsequently, the laminated article was fired at about 1,200° C. for about 2 hours to form a sintered block. The resulting block was cut into sintered ceramic bodies each having a length of about 7 mm, a width of about 7 mm, and a thickness of about 5 mm.

Each of the sintered ceramic bodies was subjected to sputtering with a Ag target to form electrodes on both main surfaces thereof. The sintered ceramic bodies were polarized in the thickness direction by application of an electric field of about 10.0 kV/mm in an oil bath at about 200° C. for about 30 minutes. In the same manner as in sample 1, the polarized ceramic bodies were cut with a dicer into pieces each having a width (x) of about 2 mm, a length (y) of about 2 mm, and a thickness (t) of about 5 mm. Silver leads were bonded to electrode faces by soldering. Thereby, PZT specimens of sample 3 were produced, each of the PZT specimens having the displacement direction the same as the polarization direction.

### Sample 4

Sintered ceramic bodies each having a length of about 7 mm, a width of about 7 mm, and a thickness of about 5 mm were prepared by the same method and procedure as in sample 3. The sintered ceramic bodies were cut into pieces each having a width (x) of about 5 mm, a length (y) of about 2 mm, and a thickness (t) of about 2 mm. Electrodes were formed on two surfaces opposing each other and having a width (x) of about 5 mm and a length (y) of about 2 mm by sputtering with a Ag target. After the formation of the electrodes, the resulting pieces were polarized in the thickness direction by application of an electric field of about 10.0 kV/mm in an oil bath at about 200° C. for about 30 minutes. Δs shown in FIG. 5, silver leads 13′ and 14′ were bonded to electrode faces 11′ and 12′ by soldering. Thereby, PZT specimens 15′ of sample 4 having the displacement direction E perpendicular to the polarization direction F were produced.

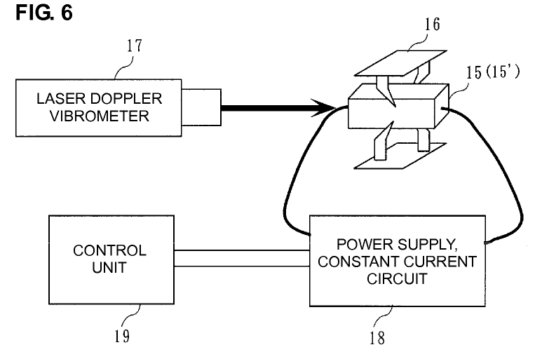

FIG. 6 is a schematic block diagram of a measuring device used for the characteristic evaluation of each of the samples.

The measuring device includes a specimen-supporting member 16 configured to support the specimen 15 (15′), a laser Doppler vibrometer 17 configured to detect the amount of displacement and the vibration velocity during vibration; a power source and constant current circuit 18 configured to apply an electric field to the specimen 15 (15′) and control a driving voltage such that a constant current is maintained, and a control unit 19 having an input-output section and the like and configured to control the power source and constant current circuit 18, the control unit 19 being electrically connected to the power source and constant current circuit 18.

The middle portion of the specimen 15 (15′) in the displacement direction was supported by the specimen-supporting member 16. An electric field was applied to the specimen 15 (15′) on the basis of a signal from the power source and constant current circuit 18. Resonance characteristics were measured to determine the resonance frequency fr. In this example, the lowermost resonance frequency was defined as the resonance frequency fr.

The mechanical quality factor Qm was determined based on an impedance curve in the vicinity of the resonance frequency fr.

The vibration velocity at an end surface of the specimen 15 (15′) was measured with the laser Doppler vibrometer 17 while electric fields having various field strengths were applied to the specimen 15 (15′) based on signals from the power source and constant current circuit 18. In samples 3 and 4, an increase in applied electric field E causes the destabilization of the vibration velocity. Thus, the vibration velocity immediately before the destabilization was determined to be a saturated vibration velocity.

The amount s of displacement was measured with the laser Doppler vibrometer 17 when various electric fields E were applied to each sample. Then the rate Δs of displacement of each sample was calculated with respect to the sample when no electric field was applied thereto.

It was difficult to measure the amount of heat because the specimen was small. Thus, the power consumption was measured as an index of the amount of heat.

Table 1 shows the presence or absence of orientation, the polarization direction, vibration velocities at a power consumption of about 1 mW/mm³, about 3 mW/mm³, and about 5 mW/mm³, and the saturated vibration velocity of each of the samples.

TABLE 1

| | | | | | | | Saturated |
|---|---|---|---|---|---|---|---|
| | | | | | | | vibration |
| | | | Polarization | Vibration velocity (m/s) | | | velocity |
| Sample | Material | Orientation | direction | 1 mW/mm³ | 3 mW/mm³ | 5 mW/mm³ | (m/s) |
| 1 | SBN based | Non- | Equal to | 0.52 | 0.85 | 1.07 | >2.12 |
| | | oriented | displacement | | | | |
| | | | direction | | | | |
| 2 | SBN based | C-axis | Equal to | 0.95 | 1.32 | 1.66 | >2.62 |
| | | oriented | displacement | | | | |
| | | | direction | | | | |
| 3* | PZT based | Non- | Equal to | 0.50 | 0.79 | 0.94 | 0.94 |
| | | oriented | displacement | | | | |
| | | | direction | | | | |
| 4* | PZT based | Non- | Perpendicular | 0.52 | 0.72 | 0.82 | 0.78 |
| | | oriented | to | | | | |
| | | | displacement | | | | |
| | | | direction | | | | |

Samples with asterisks were out of the scope of the present invention.

Δs shown in Table 1, since sample 3 included the displacement elements made of the PZT piezoelectric ceramic material, the vibration velocities were about 0.50 m/s at a power consumption of about 1 MW/mm³, about 0.79 m/s at a power consumption of about 3 mW/mm³, and about 0.94 m/s even at a power consumption of about 5 mW/mm³. That is, a large vibration velocity exceeding about 1 m/s was not obtained. Moreover, the saturated vibration velocity was as small as about 0.94 m/s. Thus, the results demonstrated that stable operation was achieved only in a low vibration velocity range.

Since sample 4 included the displacement elements made of the PZT piezoelectric ceramic material similar to sample 3, the vibration velocities were about 0.52 m/s at a power consumption of about 1 MW/mm³ about 0.72 m/s at a power consumption of about 3 mW/mm³, and about 0.82 m/s even at a power consumption of about 5 mW/mm³. That is, a large vibration velocity exceeding about 1 m/s was not obtained. Moreover, the saturated vibration velocity was as small as about 0.78 m/s. Thus, the results demonstrated that stable operation was achieved only in a low vibration velocity range. Furthermore, the displacement direction of sample 4 was substantially perpendicular to the polarization direction. Thus, the saturated vibration velocity was lower than that of sample 3. The results demonstrated that only a low vibration velocity was obtained even at a higher power consumption.

In contrast, in sample 1 made of the SBN piezoelectric ceramic material, the vibration velocity at a power consumption of about 1 mW/mm³ was substantially the same as those of samples 3 and 4. At a power consumption of about 3 mW/mm³, the vibration velocity was about 0.85 m/s. At a power consumption of 5 mW/mm³, the vibration velocity was about 1.07 m/s. These vibration velocities were slightly higher than those of samples 3 and 4. When the applied electric field E was increased, the silver leads were broken at a vibration velocity of about 2.12 m/s. That is, the saturated vibration velocity was at least about 2.12 m/s. The results demonstrated that a high saturated vibration velocity was obtained.

In sample 2, the vibration velocities were about 0.95 m/s at a power consumption of about 1 mW/mm³, about 1.32 m/s at a power consumption of about 3 mW/mm³, and about 1.66 m/s at a power consumption of about 5 mW/mm³. Accordingly, the c-axis orientation resulted in a further increase in vibration velocity compared with sample 1. When the applied electric field E was increased, the silver leads were broken at a vibration velocity of about 2.62 m/s. That is, the saturated vibration velocity was at least about 2.62 m/s or more. The results demonstrated that a high saturated vibration velocity was obtained.

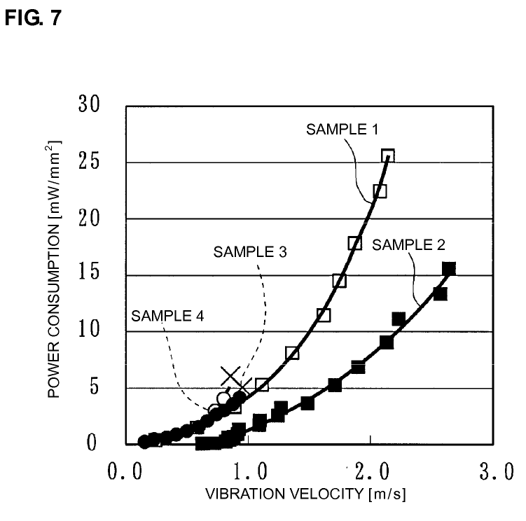

FIG. 7 shows the dependence of the power consumption on vibration velocity. The horizontal axis represents the vibration velocity v. The vertical axis represents the power consumption W. The symbol □ represents sample 1. The symbol ▪ represents sample 2. The symbol represents sample 3. The symbol ◯ represents sample 4. In the figure, the symbol x represents a point where the vibration velocity v was destabilized.

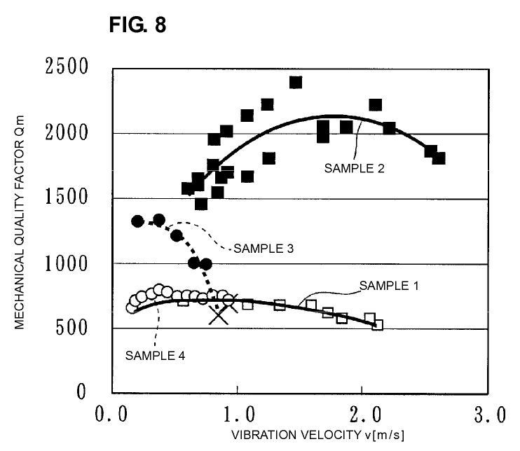

FIG. 8 shows the dependence of the mechanical quality factor on vibration velocity. The horizontal axis represents the vibration velocity v. The vertical axis represents the mechanical quality factor Qm. The symbol □ represents sample 1. The symbol ▪ represents sample 2. The symbol represents sample 3. The symbol ◯ represents sample 4. In the figure, the symbol x represents a point where the vibration velocity v was destabilized.

FIGS. 7 and 8 clearly show that in sample 1 made of the non-oriented SBN piezoelectric ceramic material, the power consumption W at a vibration velocity v of about 1.0 m/s or less was substantially the same as those of samples 3 and 4. Thus, the amount of heat was also substantially the same. FIG. 8 clearly shows that in sample 1, the mechanical quality factor Qm correlated to the amount of heat at a vibration velocity v of about 1.0 m/s or less was substantially the same as that of sample 4.

In contrast, in sample 2 made of the c-axis oriented SBN material, as shown in FIG. 7, the power consumption W was significantly less than those of samples 3 and 4 each made of the PZT material. Accordingly, the results demonstrated that the amount of heat was also small. Furthermore, FIG. 8 clearly shows that sample 2 has a mechanical quality factor Qm that is greater than those of samples 3 and 4.

Resonant actuators preferably have a power consumption W of less than about 1 mW/mm³. In the PZT piezoelectric ceramic material (sample 3 and 4), the power consumption W exceeded about 1 mW/mm³ at a vibration velocity v of at least about 0.50 m/s. In contrast, in the c-axis oriented SBN piezoelectric ceramic material (sample 2), the power consumption W was suppressed to be about 1 mW/mm³ or less even at a vibration velocity v of about 0.95 m/s. The results demonstrated that the c-axis oriented SBN piezoelectric ceramic material was suitable for applications in which the vibration velocity v exceeded about 0.50 m/s.

Comparison of samples 1 and 2 showed that as shown in Table 1, the vibration velocity v of c-axis oriented sample 2 was greater than that of non-oriented sample 1 at the same power consumption W and that as is apparent from FIGS. 7 and 8, the power consumption W of sample 2 was less than that of sample 1 at the same vibration velocity v, and the mechanical quality factor Qm of sample 2 was larger than that of sample 1. These results demonstrated that the use of the c-axis oriented SBN piezoelectric ceramic material further improved the characteristics.

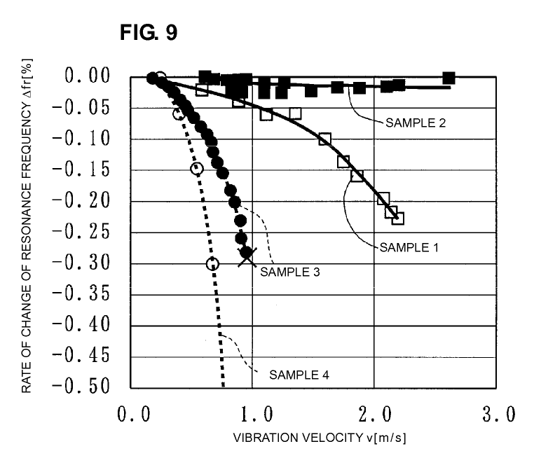

FIG. 9 shows the dependence of the resonance frequency on vibration velocity. The horizontal axis represents the vibration velocity v. The vertical axis represents the rate Δfr of change of the resonance frequency. The symbol □ represents sample 1. The symbol ▪ represents sample 2. The symbol represents sample 3. The symbol ◯ represents sample 4. In the figure, the symbol x in sample 3 represents a point where the vibration velocity v was destabilized.

FIG. 9 clearly shows that in each of samples 3 and 4 made of the PZT piezoelectric ceramic material, the rate Δfr of change of the resonance frequency is increased with increasing vibration velocity v, i.e., the resonance frequency fr is significantly reduced with increasing vibration velocity v.

In contrast, in sample 1 made of the non-oriented SBN material, the rate Δfr of change of the resonance frequency was low. In c-axis oriented sample 2, substantially no change in resonance frequency fr was observed even when the vibration velocity v was increased.

For resonant actuators, the rate Δfr of change of the resonance frequency is preferably in the range of about −0.05%. In the PZT piezoelectric ceramic material (samples 3 and 4), however, when the vibration velocity v exceeded about 0.5 m/s, the rate Δfr of change of the resonance frequency exceeded about −0.05% and decreased significantly.

In contrast, it was found that in the non-oriented SBN piezoelectric material (sample 1), the rate Δfr of change of the resonance frequency was suppressed to be within about −0.05% until the vibration velocity v reached about 1.0 m/s and that the material may be preferably used for a resonant actuator in this vibration velocity v range. Furthermore, it was found that in the c-axis oriented SBN material (sample 2), the rate Δfr of change of the resonance frequency was reduced to only about −0.03% even when the vibration velocity v reached about 2.0 m/s. Therefore, the results demonstrated that the SBN piezoelectric ceramic material was further suitable for applications in which the vibration velocity v exceeded about 0.50 m/s.

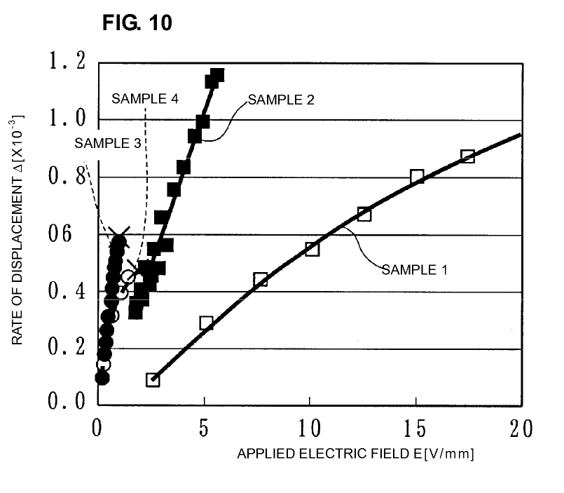

FIG. 10 shows the dependence of the rate of displacement on electric field. The horizontal axis represents the applied electric field E. The vertical axis represents the rate Δs of displacement. The symbol □ represents sample 1. The symbol ▪ represents sample 2. The symbol represents sample 3. The symbol ◯ represents sample 4. In the figure, the symbol x represents a point where the vibration velocity v was destabilized.

FIG. 10 clearly shows that when the applied electric field E is increased, in sample 3 of samples 3 and 4 composed of the PZT material, the vibration velocity v is destabilized at an applied electric field E of about 1 V/mm, and in sample 4, the vibration velocity v is destabilized at an applied electric field E of about 1.8 V/mm.

In contrast, it was found that in samples 1 and 2 made of the SBN materials, the rate Δs of displacement increased in approximate proportion to an increase in applied electric field E. That is, it was found that a large amount s of displacement was obtained even at a high applied electric field.

In EXAMPLE 1, each sample operated at the lowermost resonance frequency fr. It was found that even when each sample operated at higher order resonant frequencies, the same effect was provided.

In EXAMPLE 1, the single-plate displacement elements were used. It should be noted that also in the case of multilayer displacement elements being used, the same effect is provided.

### Example 2

Various SBN samples having different degrees of c-axis orientation F were produced, and characteristics thereof were evaluated.

A calcined powder and plate-shaped ceramic particles were prepared by the same method and procedure as in sample 2 described in “EXAMPLE 1”.

The plate-shaped ceramic particles and the calcined powder were mixed in different ratios by weight in such a manner that the degrees of c-axis orientation F of sintered ceramic bodies were about 54%, about 75%, and about 95%. SBN specimens of sample 22 (degree of orientation F: 54%), sample 23 (degree of orientation F: about 75%), and sample 24 (degree of orientation F: about 95%) were prepared by the same methods and procedures as in Sample 2.

The degree of orientation F of each of samples 22 to 24 was calculated by the Lotgering method in the same manner as sample 2 described in “EXAMPLE 1”.

Non-oriented SBN specimens as sample 21 were prepared as in sample 1.

The vibration velocity v, the resonance frequency fr, and the power consumption W of each of samples 21 to 24 at various applied electric fields E were measured by the same methods and procedures as in “EXAMPLE 1”.

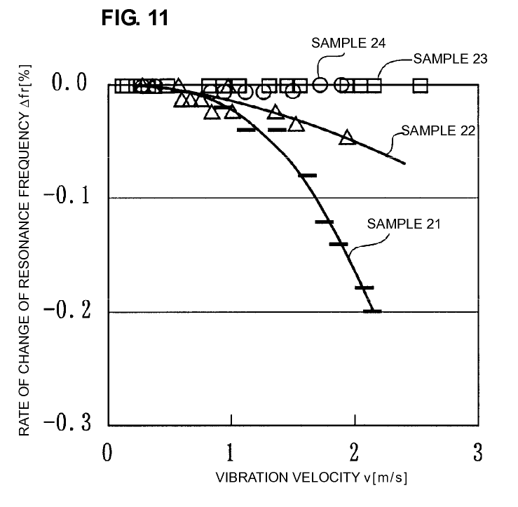

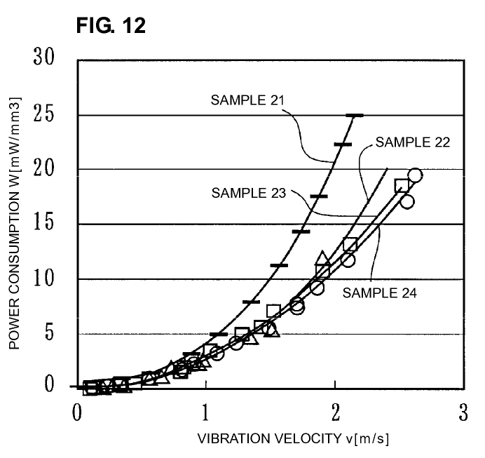

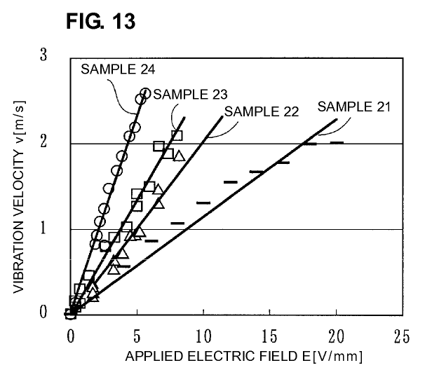

FIG. 11 shows the dependence of the resonance frequency on vibration velocity. The horizontal axis represents the vibration velocity v. The vertical axis represents the rate Δfr of change of the resonance frequency. FIG. 12 shows the dependence of the power consumption on vibration velocity. The horizontal axis represents the vibration velocity v. The vertical axis represents the power consumption W. FIG. 13 shows the dependence of the vibration velocity on electric field. The horizontal axis represents the applied electric field E. The vertical axis represents the vibration velocity v. In each of the figures, the symbol - represents sample 21. The symbol A represents sample 22. The symbol 0 represents sample 23. The symbol 0 represents sample 24.

The results shown in FIG. 11 clearly demonstrate that since sample 21 was not oriented and sample 22 had a low degree of c-axis orientation F of about 54%, the rates Δfr of change of the resonance frequencies shifted to negative values at a vibration velocity v of about 1 m/s or more, so that the resonance frequencies were reduced.

In contrast, it was found that in each of sample 23 having a degree of orientation F of 75% and sample 24 having a degree of orientation F of 90%, the rate Δfr of change of the resonance frequency was substantially zero even at a vibration velocity v of 1 m/s or more, and thus a change in resonance frequency fr was inhibited.

The results shown in FIG. 12 clearly demonstrate that in each of sample 23 having a degree of c-axis orientation F of about 75% and sample 24 having a degree of c-axis orientation F of about 90%, the degree of an increase in power consumption W with increasing vibration velocity v was less than those of non-oriented sample 21 and sample 22 having a degree of orientation F of about 54%, i.e., savings in power consumption W were achieved. At the degrees of c-axis orientation F of about 75% and about 90%, the power consumption was substantially the same. Thus, it was found that the power consumption W was substantially saturated at a degree of c-axis orientation F of at least about 75%.

As shown in FIG. 13, the results demonstrated that in any of samples 21 to 24, the vibration velocity v increased substantially in proportion to the applied electric field E and that a large vibration velocity v was obtained at a low applied electric field E as the degree of c-axis orientation F was increased.

Consequently, it was found that the bismuth layered compound was preferably oriented such that the direction of the c-axis was substantially perpendicular to the polarization direction. In this case, it was found that more preferably, the degree of c-axis orientation F was at least about 75%.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A resonant actuator comprising:
at least one driving unit and a driven member, said at least one driving unit including a displacement element that vibrates at a resonance frequency or in a frequency range in the vicinity of a resonance frequency, and said driven member being driven by the displacement element; wherein
the displacement element includes a piezoelectric ceramic body made of a bismuth layered compound.

2. The resonant actuator according to claim 1, wherein a displacement direction of the displacement element is substantially the same as a direction of polarization of the piezoelectric ceramic body.

3. The resonant actuator according to claim 1, wherein the bismuth layered compound is oriented such that a direction of a c crystallographic axis is substantially perpendicular to a direction of polarization of the piezoelectric ceramic body.

4. The resonant actuator according to claim 3, wherein a degree of c-axis orientation is at least about 75% as determined by the Lotgering method.

5. The resonant actuator according to claim 1, wherein the bismuth layered compound is one of Bi₂SrNb₂O₉, BiWO₆, CaBiNb₂O₉, BaBiNb₂O₉, PbBi₂Nb₂O₉, Bi₃TiNbO₉, Bi₃TiTaO₉, Bi₄Ti₃O₁₂, SrBi₃Ti₂NbO₁₂, BaBi₃Ti₂NbO₁₂, PbBi₃Ti₂NbO₁₂, CaBi₄Ti₄O₁₅, SrBi₄Ti₄O₁₅, BaBi₄Ti₄O₁₅, PbBi₄Ti₄O₁₅, Na_{0.5}Bi_{4.5}Ti₄O₁₅, K_{0.5}Bi₄Ti₄O₁₅, Ca₂Bi₄Ti₅O₁₈, Sr₂Bi₄Ti₅O₁₈, Ba₂Bi₄Ti₅O₁₈, Bi₆Ti₃WO₁₈, Bi₇Ti₄NbO₂₁, and Bi₁₀Ti₃W₃O₃₀.

6. The resonant actuator according to claim 1, wherein the piezoelectric ceramic body is a single-plate piezoelectric ceramic body.

7. The resonant actuator according to claim 1, wherein the at least one driving unit includes a vibrating reed arranged to protrude from the displacement element.

8. The resonant actuator according to claim 1, wherein the displacement element includes electrodes arranged on both main surfaces of the piezoelectric ceramic body.

9. The resonant actuator according to claim 8, wherein the electrodes are made of Ag.

10. A resonant actuator comprising:
first and second driving units and a driven member, each of said first and second driving units including a displacement element that vibrates at a resonance frequency or in a frequency range in the vicinity of a resonance frequency, and said driven member being driven by the displacement elements of the first and second driving units; wherein
each of the displacement elements includes a piezoelectric ceramic body made of a bismuth layered compound.

11. The resonant actuator according to claim 10, wherein a displacement direction of the displacement element of each of the first and second driving units is substantially the same as a direction of polarization of the piezoelectric ceramic body.

12. The resonant actuator according to claim 10, wherein the bismuth layered compound is oriented such that a direction of a c crystallographic axis is substantially perpendicular to a direction of polarization of the piezoelectric ceramic body of the displacement element of each of the first and second driving units.

13. The resonant actuator according to claim 12, wherein a degree of c-axis orientation is at least about 75% as determined by the Lotgering method.

14. The resonant actuator according to claim 10, wherein the bismuth layered compound is one of Bi₂SrNb₂O₉, BiWO₆, CaBiNb₂O₉, BaBiNb₂O₉, PbBi₂Nb₂O₉, Bi₃TiNbO₉, Bi₃TiTaO₉, Bi₄Ti₃O₁₂, SrBi₃Ti₂NbO₁₂, BaBi₃Ti₂NbO₁₂, PbBi₃Ti₂NbO₁₂, CaBi₄Ti₄O₁₅, SrBi₄Ti₄O₁₅, BaBi₄Ti₄O₁₅, PbBi₄Ti₄O₁₅, Na_{0.5}Bi_{4.5}Ti₄O₁₅, K_{0.5}Bi₄Ti₄O₁₅, Ca₂Bi₄Ti₅O₁₈, Sr₂Bi₄Ti₅O₁₈, Ba₂Bi₄Ti₅O₁₈, Bi₆Ti₃WO₁, Bi₇Ti₄NbO₂₁, and Bi₁₀Ti₃W₃O₃₀.

15. The resonant actuator according to claim 10, wherein the piezoelectric ceramic body of at least one of the first and second driving units is a single-plate piezoelectric ceramic body.

16. The resonant actuator according to claim 10, wherein at least one the first and second driving units includes a vibrating reed arranged to protrude from the displacement element.

17. The resonant actuator according to claim 10, wherein the displacement element of at least one of the first and second driving units includes electrodes arranged on both main surfaces of the piezoelectric ceramic body.

18. The resonant actuator according to claim 17, wherein the electrodes are made of Ag.
